(19) United States
(12) Patent Application Publication
(10) Pub. No.: US 2004/0085930 A1
(43) Pub. Date: May 6, 2004

(54) Radio device capable of anticipating a link state and method thereof

(76) Inventors: Lung-Sheng Lee, Hsin-Chu City (TW); Jui-Cheng Chen, Chang-Hua Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,585

(22) Filed: Oct. 31, 2002

(51) Int. Cl. H04Q 7/00

(52) U.S. Cl. 370/330; 375/132

(57) ABSTRACT

A radio device operating under a time division duplex frequency hopping scheme has a standby link state and a connection link state. The radio device includes two register sets, one for standby link state frequency channel parameters and one for connection link state frequency channel parameters. A multiplexer as controlled by a link state controller outputs selected link state frequency channel parameters to a working register set. According to a periodic timer the selected link state frequency channel parameters are forwarded from the working register set to a frequency channel controller that controls an RF device. The frequency channel parameters for a next time slot are loaded in the registers during a current time slot so that the required frequency channel parameters are readily available for operation of the radio device.

### BACKGROUND OF INVENTION

1. Field of the Invention

The present invention relates to a radio device, and more specifically, to a radio device used in a time division duplex frequency hopping system.

2. Description of the Prior Art

Wireless connection schemes for electronic devices are becoming increasingly popular. Currently, people can interconnect their mobile telephones, personal digital assistants (PDAs), and notebook computers to form small information sharing networks. Wireless technology is poised to take over the duties now mostly performed by physical wire cables.

A recently develop standardization format for wireless communications between electronic devices is Bluetooth (TM) as detailed in the “Specification of the Bluetooth System” currently at revision V 1.1. While in the past other formats have been introduced, such as Apple″s AirPort (TM) and other wireless LAN formats in accordance with IEEE 802.11, the Bluetooth specification purports to have advantages of simplicity, cost, and robustness. Bluetooth is a time division duplex frequency hopping system of communication. That is, the radio frequency used for communication between devices of a network, know as a piconet, is randomly changed between 79 possible frequencies at a rate of 1600 cycles per second. This requires devices to communicate at a given frequency for 625 microseconds, termed a time slot, before switching to a new predetermined frequency, and ensures that interference between piconets or other devices utilizing the same frequency is minimized. Moreover, Bluetooth prescribes a master-slave relationship between devices of a piconet. Further information can be found in the Bluetooth specification.

Please refer to FIG. 1 showing a prior art radio device 10 for use in a wireless network such as a Bluetooth piconet. The radio device 10 includes a register set 14, a frequency channel controller 16, and an RF device 18. The radio device 10 is typically made of a combination of IC chips and solid-state devices. The register set 14 is forwarded frequency channel parameters by a software based interrupt service routine (ISR) 20 to set the frequency channel controller 16 to a frequency appropriate for a current time slot. The frequency channel controller 16 then controls the RF device 18 to enable the radio device 10 to communicate with other devices at the frequency of the current time slot. The software ISR 20 regularly calculates and forwards the register set 14 new frequency channel parameters so that frequency hopping is achieved according to whether the radio device 10 is in a standby link state (waiting to be connected to another device) or a connection link state (already connected). The software ISR 20 includes at least two calculation algorithms, one for the standby link state and one for the connection link state, and sends the resulting frequency channel parameters to the register set 14 as soon as the relevant calculation is complete.

Referring to FIG. 2 showing a timeline of time slots used by the radio device 10, time slots TS₀ to TS₄ are illustrated as an example. Times t₀ to t₄ are the times when the radio device 10 initiates a frequency change and thus designate practical ends of the time slots TS₀ to TS₄ respectively and are accordingly offset from the theoretical ends of the time slots TS₀ to TS₄ by a radio frequency settling time RFST.

The settling time RFST is a time required by the radio device 10 to stabilize at a new operating frequency. For instance, at the time t₀ the frequency channel controller 16 controls the RF device 18 to operate at a specific frequency for communication during the time slot TS₁. However, the radio device 10 is not ready to function at this frequency until the settling time RFST has elapsed. Typically, the settling time RFST is constant for a given radio device 10.

Suppose that the radio device 10 is in the standby link state, that is, it is detecting for other radio devices with the aim of becoming a master or a slave of a network. Accordingly, information transmitted and received during the time slot TS₀ is relevant to substates such as page scan, inquiry, and inquiry response. At time t₀ the radio device 10 initiates a frequency change according to the software ISR 20 according to the standby link state algorithm which presupposes that the radio device 10 is not part of a network (i.e. the frequency change does not have to be synchronized with any other device). Now, as represented by a time L on the timeline of FIG. 2, a connection is made to another device (either as a master or as a slave). The radio device 10 must now switch into the connection link state. Furthermore, to ensure quick and reliable performance the radio device 10 should switch into the connection link state prior to the time t₁.

When switching into the connection link state, the software ISR 20 must calculate the connection frequency channel parameters for the new time slot TS₂ and the radio device 10 must load these parameters into the register set 14 to override the anticipated and already loaded standby values. This extra calculation procedure takes time and specifically must be performed during a so-called processing time PT to be completed ahead of the next frequency change initiation time t₁. As the processing time PT can be in the order of microseconds the software ISR 20 used with the conventional radio device 10 must be capable of processing algorithms at a high clock rate. Furthermore, if the processing time PT is too short, the radio device 10 must wait until the next time slot TS₂ to perform the calculation. Moreover, this situation can occur whenever the radio device 10 changes between any link states (such as connection to standby) and requires that different frequency channel parameters be calculated. The prior art technology results in an inefficient design that requires high-speed calculation and thus has high power consumption.

### SUMMARY OF INVENTION

It is therefore a primary objective of the claimed invention to provide a radio device that can anticipate a future link state to overcome the problems of the prior art.

Briefly summarized, the preferred embodiment of the claimed invention discloses a radio device having a standby link state and a connection link state, the radio device operating under a frequency hopping scheme wherein the radio device changes frequencies according to the link state and according to a periodic timer that defines regular time slots. The radio device comprises two register sets, one for standby link state frequency channel parameters and one for connection link state frequency channel parameters. A multiplexer as controlled by a link state controller outputs selected link state frequency channel parameters to a working register set. According to the periodic timer the selected link state frequency channel parameters are forwarded from the working register set to a frequency channel controller that controls an RF device.

According to the claimed invention, before the radio device changes frequencies from a current time slot to a next time slot the standby frequency channel parameters for the next time slot and the connection frequency channel parameters for the next time slot are stored in the first and second register sets respectively. Moreover, the link state controller is capable of switching the multiplexer according to the link state of the radio device for the next time slot so that the selected frequency parameters are loaded into the working register set.

According to the claimed invention, the standby and connection frequency channel parameters are determined by a software interrupt service routine (ISR) for the next time slot during the current time slot.

It is an advantage of the claimed invention that the first and second register sets provide the frequency channel parameters for both possible link states so that the frequency channel parameters are readily available for a quick change of link state.

It is a further advantage of the claimed invention that the software ISR is relieved from operating at a high clock rate needed to quickly calculate the frequency channel parameters, thereby saving power.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic diagram of a prior art radio device for use in a wireless network.

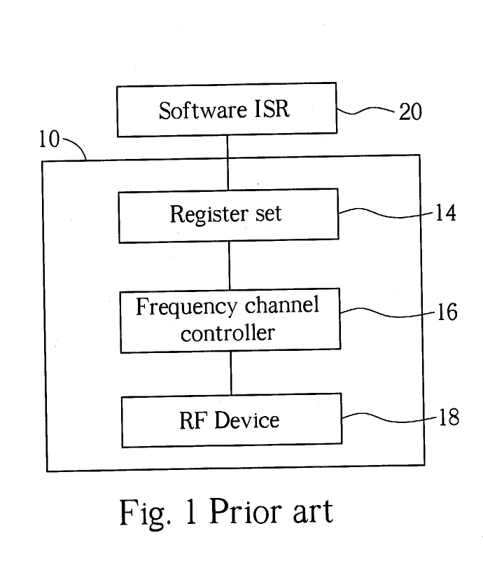

FIG. 2 is a timeline diagram of time slots used by a radio device.

FIG. 3 is a schematic diagram of a radio device according to the present invention.

### DETAILED DESCRIPTION

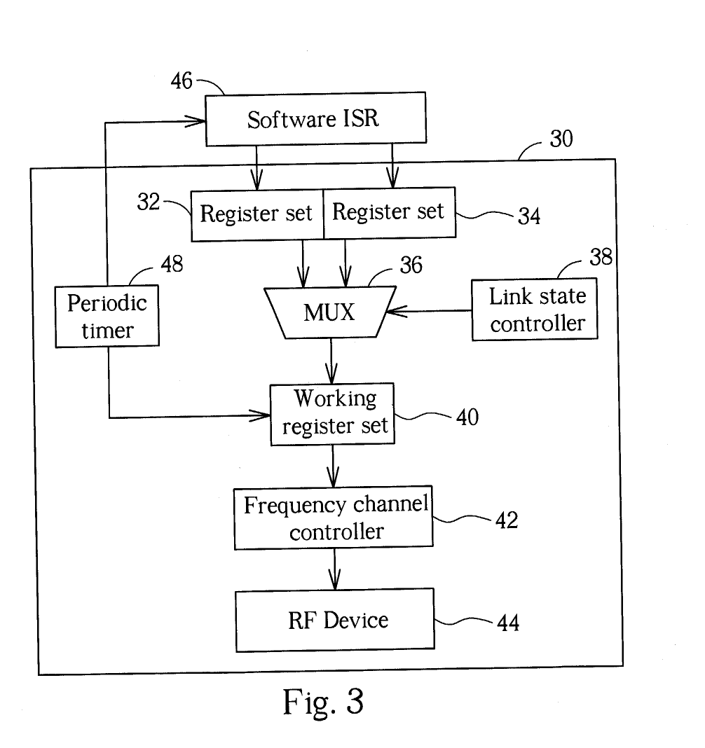

Please refer to FIG. 3 showing a schematic diagram of a radio device 30 according to the preferred embodiment of the present invention. The radio device 30 comprises a first register set 32, a second register set 34, a multiplexer 36 connected to outputs of the register sets 32 and 34, and a link state controller 38 connected to a selection input of the multiplexer 36. The multiplexer 36 in controlled by the link state controller 38 to output either contents of the register sets 32 or contents of the register set 34. The radio device 30 further includes a working register set 40 connected to the output of the multiplexer 36, a frequency channel controller 42 for controlling an RF device 44, and a periodic timer 48. The radio device 30 accepts input from a software interrupt service routine (ISR) 46 at the register sets 32 and 34.

The periodic timer 48 is used for synchronizing the software ISR 46 and the working register set 40. The radio device 30 as illustrated in FIG. 3 can be realized with IC chips, solid-state devices, or a combination of these.

The radio device 30 operates according to a time division duplex frequency hopping system of communication such as the aforementioned Bluetooth system. That is, frequencies used for communication with other radio devices via the RF device 44 are randomly selected according to a link state. Valid link states include a standby link state where the radio device 30 is waiting for a connection, and a connection link state where the radio device 30 is connected as a master or as a slave to other similar radio devices to form a network. Accordingly, the software ISR 46 is capable of calculating frequency channel parameters for these link states for operation of the radio device 30. In addition, the source of the periodic timer 48 depends on the link state. In the standby link state the periodic timer 48 comes from an internal clock (not shown) of the radio device 30, while in the connection link state the periodic timer 48 can originate from another radio device in the network.

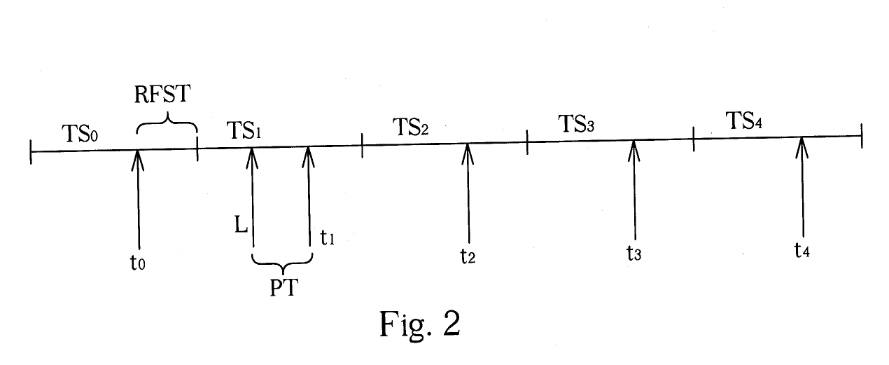

Fundamental to the operation of the present invention radio device 30 is that the register sets 32 and 34 store frequency channel parameters for the standby link state and the connection link state respectively. The software ISR 46 calculates these parameters based on the specific system that the radio device is used in (Bluetooth, etc.) and forwards them to the respective register sets 32 and 34 according to the periodic timer 48. This results in a timeline as illustrated in FIG. 2. The periodic timer 48 defines a continuous range of time slots of which four time slots TS₀ to TS₄ are illustrated as an example, and also defines related times t₀ to t₄ that are time slot initiation times. For each of the time slots TS₀ to TS₄ and depending on the link state of the radio device 30, the software ISR 46 calculates frequency channel parameters. It is important to note that the channel frequency parameters usually have to be calculated on the fly as the frequency assignment originates from an outside source (e.g. network master or system clock). Once the standby link state frequency channel parameters are loaded into the register set 32 and the connection link state frequency channel parameters are loaded into the register set 34, the radio device 30 must select the appropriate frequency channel parameters for transmission and reception.

The frequency channel parameters required for a given time slot are selected by the multiplexer 36 as controlled by the link state controller 38. The link state controller 38 determines the link state of the radio device 30 and toggles the multiplexer 36 accordingly. The selected frequency channel parameters are then inputted into the working register set 40. The working register set 40, as signaled by the periodic timer 48, sends the selected frequency channel parameters to the frequency channel controller 42. The periodic timer 48 ensures the working register set 40 and the software ISR 46 are synchronized. Thus, the radio device 30 can use the proper frequency channel parameters to establish, continue, or disestablish its connection to the network.

Referring to FIG. 2 and FIG. 3, consider the following example of the operation of the present invention radio device 30.

1. The radio device 30 is operating in a standby link state and is thus not a member of a network. The software ISR 46 is continually calculating both standby and connection link state frequency channel parameters and forwarding these parameters to the register sets 32 and 34 respectively. The rate of calculating these parameters is controlled by the periodic timer 48 (1600 cycles per second for Bluetooth). The link state controller 38 is set to “standby” such that the frequency channel controller 42 receives the updated standby frequency parameters from the register set 32 at the required times, and the RF device 44 sends and receives signals accordingly.

2. At the time L the radio device 30 agrees to a connection with another radio device to become a slave in a network beginning at the time slot TS₂ initiated at the time t₁.

3. After the time L but before the time t₁, the link state controller 38 detects the new link state and switches to “connection” thereby loading the connection frequency channel parameters from the register set 34 into the working register set 40.

4. At the time t the periodic timer 48 triggers the working register set 40 to forward the connection frequency channel parameters to the frequency channel controller 42 such that the RF device 44 begins to operate at the connection frequency. Also at this time, the periodic timer 48 interrupts the software ISR 46 so that the software ISR 46 can begin calculation the standby and connection frequency channel parameters for the time slot TS₃.

5. From the time t₁ to the beginning of the time slot TS₂ the RF device 44 undergoes frequency settling and stabilization.

6. From the beginning of the time slot TS₂ to the time t₂, the radio device 30 operates in the connection link state as a slave or master in the network. Depending on the connection, the radio device 30 may operate in the connection link state well past the time slot TS₄.

With respect to the above-described procedure, the radio device 30 can of course be a master or a slave in the network. Furthermore, the procedure is valid for the reverse transition (connection to standby) or transitions between other link states.

By pre-calculating both possible sets of frequency channel parameters, loading these parameters into the respective register sets, and selecting the required frequency channel parameters, the radio device 30 according to the present invention minimizes, if not eliminates, potential waste of resources by a processing time PT shown in FIG. 2. That is to say, the software ISR 46 is relieved of having to wait until the link state is agreed upon (as indicated by L in FIG. 2 for example) and then having to hastily calculate new frequency channel parameters if the anticipated link state is in error. Thus a minimum processing time PT required is effectively reduced to the response time of the working register set 40 and the frequency channel controller 42. According to the present invention, the processing time PT is independent of the speed of calculation of the software ISR 46. Moreover, the software ISR 46 has an extended time (e.g. t₂ t₁) in which to calculate both sets of frequency channel parameters and thus can operate at a reduced clock rate and at a reduced power, when compared to being used in conjunction with the prior art radio device 10.

Naturally, the present invention can be extended to more than two link states by incorporating an additional register set for each additional link state. The present invention can also be applied to other communications networks besides Bluetooth systems.

In contrast to the prior art, the present invention uses two register sets to store frequency channel parameters for two link states that can be selected by a multiplexer thereby effectively anticipating a link state of a radio device. The present invention thus greatly reduces a processing time constraint of a software ISR, and in doing so reduces power consumption.

Those skilled in the art will readily observe that numerous modifications and alterations of the device may be made while retaining the teachings of the invention.

Accordingly, the above disclosure should be construed as limited only by the metes and bounds of the appended claims.

What is claimed is:

1. A radio device capable of anticipating a link state as being a standby link state or a connection link state, the radio device operating under a frequency hopping scheme wherein the radio device changes frequencies according to the link state and according to a periodic timer that defines regular time slots, the radio device comprising:
a first register set for storing standby frequency channel parameters relating to the standby link state;
a second register set for storing connection frequency channel parameters relating to the connection link state;
a multiplexer connected to outputs of the first and second register sets for selecting and outputting either the standby or connection frequency channel parameters;
a link state controller connected to a selection input of the multiplexer for controlling the multiplexer according to the link state of the radio device;
a working register set connected to the output of the multiplexer for receiving the selected frequency channel parameters output by the multiplexer; and
a frequency channel controller connected to the working register set for controlling the radio device according to the selected frequency channel parameters;
wherein before the radio device changes frequencies from a current time slot to a next time slot the standby frequency channel parameters for the next time slot and the connection frequency channel parameters for the next time slot are stored in the first and second register sets respectively, such that the link state controller is capable of switching the multiplexer according to the link state of the radio device for the next time slot so that the selected frequency parameters are loaded into the working register set.

2. The radio device of claim 1 wherein the standby and connection frequency channel parameters are determined by a software interrupt service routine (ISR) for the next time slot during the current time slot.

3. The radio device of claim 1 wherein the selected frequency channel parameters are loaded into the working register set ahead of the next time slot as indicated by the periodic timer.

4. The radio device of claim 1 further comprising an RF device connected to the frequency channel controller for transmitting and receiving radio signals according to the selected frequency channel parameters.

5. The radio device of claim 4 wherein the link state controller switches the multiplexer ahead of the next time slot by a predetermined RF settling time of the RF device.

6. The radio device of claim 4 wherein the radio device is designed and manufactured according to the Specification of the Bluetooth System for wireless communications.

7. The radio device of claim 1 wherein each link state has a different set of frequencies that are cycled through according to the frequency hopping scheme.

8. The radio device of claim 1 wherein the link state is determined by information received from a second radio device.

9. The radio device of claim 1 wherein when in the standby link state the periodic timer is generated by the radio device, and when in the connection link state the periodic timer is generated by and received from a second radio device.

10. The radio device of claim 1 further comprising additional link states and an additional register set for each additional link state, wherein the multiplexer is further connected to outputs of the additional register sets for further selecting and outputting frequency channel parameters of the additional register sets.

11. A method for setting a link state for a radio device, the radio device comprising a first register set, a second register set, and a frequency channel controller, the radio device operating under a frequency hopping scheme wherein the radio device changes frequencies according to the link state and according to a periodic timer that defines regular time slots, the method comprising:
storing standby frequency channel parameters for a next time slot in the first register set;
storing connection frequency channel parameters for the next time slot in the second register set;
selecting the standby frequency channel parameters during a current time slot when the link state of the radio device is to be a standby link state during the next time slot;
selecting the connection frequency channel parameters during the current time slot when the link state of the radio device is to be a connection link state during the next time slot; and
inputting the selected frequency channel parameters into the frequency channel controller prior to the beginning of the next time slot for controlling the radio device during the next time slot.

12. The method of claim 11 wherein the storing, selecting, and inputting steps are synchronized through the periodic timer.

13. The method of claim 11 further comprising calculating standby frequency channel parameters and connection frequency channel parameters using a software interrupt service routine (ISR) and forwarding the calculated frequency channel parameters to the first and second register sets.
